(19) United States
(12) Patent Application Publication
(10) Pub. No.: US 2024/0130366 A1
(43) Pub. Date: Apr. 25, 2024

(54) AGRICULTURAL COMPOSITION COMPRISING KASUGAMYCIN

(71) Applicants: UPL Corporation Limited, Port Louis (MU); UPL Europe LTD, Warrington (GB)

(72) Inventors: Marín Virgilio Valdés Caballero, Saltillo (MX); Susana Solis Gaona, Saltillo (MX); Paola Catalina Leija Martínez, Saltillo (MX); Mario Ramón Villareal Cárdenas, Saltillo (MX); María de Lourdes Delgado Hernandez, Saltillo (MX); Mauricio Alberto Vargas Martínez, Saltillo (MX)

(21) Appl. No.: 18/548,122

(22) PCT Filed: Feb. 28, 2022
(86) PCT No.: PCT/GB2022/050530

§ 371 Date: Aug. 27, 2023

(30) Foreign Application Priority Data
Mar. 1, 2021 (IN) 202121008445

(51) Int. Cl. A01N 43/16; A01P 1/00

(52) U.S. Cl. CPC A01N 43/16; A01P 1/00

(57) ABSTRACT

The present disclosure relates to agricultural compositions or combinations having broad spectrum anti-microbial activity. Particularly, the present disclosure provides an agricultural composition including Kasugamycin or salt thereof and a plant resistance elicitor that exhibits antifungal and antibacterial properties. Further aspects of the present disclosure relate to a liquid agricultural composition, an aqueous pre-mix agricultural formulation and a method of preparation thereof. The present disclosure further relates to a method of controlling phytopathogens.

### TECHNICAL FIELD

The present disclosure relates to agricultural combinations or compositions. Particularly, the present disclosure relates to an agricultural composition including kasugamycin or a salt thereof and a plant resistance elicitor that exhibits anti-microbial properties. Further, aspects of the present disclosure relate to a liquid agricultural formulation and a method of preparation thereof.

### BACKGROUND OF THE INVENTION

Background description includes information that may be useful in understanding the present invention. It is not an admission that any of the information provided herein is prior art or relevant to the presently claimed invention, or that any publication specifically or implicitly referenced is prior art literature.

Kasugamycin is an agricultural antibiotic bactericide that inhibits the proliferation of bacteria by tampering with their ability to make new proteins with ribosome being the major target. It exhibits both antibacterial and fungicidal properties and has been widely used. The mechanism of action of kasugamycin is to disturb the esterase system of pathogen metabolism of amino acid; destroy the biosynthesis of protein; the growth that suppresses mycelia also causes cell granulations, makes pathogen lose breeding and infection ability.

Kasugamycin is quite valued both at home and industrial level. Unfortunately, no single bactericide and fungicide is useful in all situations and repeated usage of a single bactericides or fungicides such as kasugamycin frequently leads to the development of resistance in phytopathogens towards kasugamycin and its related bactericide and fungicide compounds. Accordingly, significant efforts have been put forward towards finding new and improved combinations of bactericide, fungicide and other related material of natural or synthetic origin that are safer, have better performance, require lower dosages, easier to use and are cost effective. Combinations have also been studied that produce synergism, i.e., the activity of two, or more, agents exceed the activities of the agents when used alone. However, none of the current approaches/reports seem to satisfy the existing needs.

Moreover, the application of bactericides and fungicides in crop management has been reported to cause persistent issues relating to phytotoxicity and emergence of resistance in phytopathogens, resulting in poor disease control and massive crop loss.

There is therefore an unmet need in the art to develop an agricultural combination or composition including kasugamycin or a salt thereof and a plant resistance elicitor compound or a fertilizer that may overcome the drawbacks associated with the existing agricultural combinations/compositions and exhibits good synergy/functional reciprocity and provide broad spectrum anti-microbial, i.e. antifungal and antibacterial properties at a reduced dosage.

The present invention satisfies the existing needs, as well as others, and generally overcomes the deficiencies found in the prior art.

All publications herein are incorporated by reference to the same extent as if each individual publication or patent application were specifically and individually indicated to be incorporated by reference.

### SUMMARY

The present disclosure relates to agricultural combinations or compositions. Particularly, the present disclosure provides an agricultural composition including kasugamycin or salt thereof and a plant resistance elicitor that exhibits antifungal and antibacterial properties. The present disclosure further relates to the agriculture composition formulated as a liquid composition. Further aspects of the present disclosure relate to a liquid formulation and an aqueous pre-mix agricultural formulation and a method of preparation thereof.

The present disclosure is on the premise of a surprising finding by the inventors that combinations or compositions including kasugamycin or a salt thereof and a plant resistance elicitor also termed as an organic fertilizer elicitor exhibits good synergy and functional reciprocity therebetween, aids in reducing dosage of kasugamycin or a salt thereof otherwise required, and consequently aids in reducing or mitigating phytotoxicity. It could also be noted that the combinations or compositions aid in precluding development of resistance of phytopathogens towards kasugamycin or a salt thereof.

In an aspect, the present disclosure provides an agricultural combination comprising kasugamycin or a salt thereof and a plant resistance elicitor in a weight ratio of 1:1 to 1:50.

In an aspect, the salt of kasugamycin is kasugamycin hydrochloride hydrate.

In an aspect, the plant resistance elicitor compound or combinations thereof selected from one or more of metabolites, seaweed extracts and nutrients.

Accordingly, an aspect of the present disclosure provides an agricultural composition comprising an agriculturally effective amount of kasugamycin or a salt thereof; an agriculturally effective amount of a plant resistance elicitor and an agriculturally acceptable excipient, wherein kasugamycin or a salt thereof and a plant resistance elicitor is in a weight ratio of 1:1 to 1:50.

In a particular aspect, the plant resistance elicitor includes any or a combination of fulvic acid, salicylic acid, inositol, flavonoids, glucosamine, seaweed extract, a nitrogen source, a carbon source a potassium source, a sulphur source and a copper source.

In an aspect, the composition comprises kasugamycin or a salt thereof in an amount ranging from 0.1% to 40% w/v by weight of the composition.

In an aspect, the composition comprises kasugamycin or a salt thereof and a plant resistance elicitor in a weight ratio ranging from 1:70 to 5:1. In an aspect, the composition comprises kasugamycin or a salt thereof and the plant resistance elicitor in a weight ratio ranging from 1:50 to 2:1. In an aspect, the composition comprises kasugamycin or a salt thereof and the plant resistance elicitor in a weight ratio ranging from 1:5 to 1:50. In an aspect, the composition comprises kasugamycin or a salt thereof and the plant resistance elicitor in a weight ratio ranging from 1:15 to 1:40.

In an aspect, the composition comprises kasugamycin or a salt thereof in an amount ranging from 0.1% to 40% w/v, metabolites in an amount ranging from 0.5% to 35% w/v, a carbon source in an amount ranging from 0.05% to 5.0% w/v, a nutrient source in an amount ranging from 1% to 10% w/v and an excipient in an amount ranging from 5% to 95% w/v, each ingredient by weight of the composition.

In an aspect, the composition comprises kasugamycin or a salt thereof in an amount ranging from 0.1% to 40% w/v, fulvic acid in an amount ranging from 0.5%-35% w/v, salicylic acid in an amount ranging from 0.5%-35% w/v, inositol in an amount ranging from 0.05%-5% w/v, glucosamine in an amount ranging from 0.05%-5.0% w/v, a nutrient source in an amount ranging from 1% to 15% w/v and an excipient in an amount ranging from 5% to 95% w/v, each ingredient by weight of the composition.

In an aspect, the composition further comprises the nitrogen source in an amount ranging from 0.1%-10% w/v, the potassium source in an amount ranging from 1.0%-25% w/v, the copper source in an amount ranging from 0.05%-5.0% w/v, each ingredient by weight of the composition.

In an aspect, the composition exhibits wide spectrum antifungal and antibacterial properties. Particularly, the composition of the present disclosure is effective against Erwinia amylovora, Ralstonia solanacearum, Burkholderia gladioli, Alternaria alternata, Xanthomonas spp, Erwinia carotovora, Pyricularia oryzae, Xanthomonas axonopodispv. Vesicatoria, Burkholderia andropogonis, and Streptomyces scabies.

In an aspect, the salt of kasugamycin is kasugamycin hydrochloride hydrate.

In an aspect, the nitrogen source is urea.

In an aspect, the potassium source is a potassium salt such as potassium oxide.

In an aspect, the copper source is copper salt such as tribasic copper sulphate, copper sulphate, copper glycinate, copper monoglycinate, copper hydroxide, copper nitrate, copper oxychloride and copper chloride.

In an aspect, the sulphur source is methyl sulfonyl methane.

In an aspect, the composition is formulated as a liquid formulation.

In an aspect, the composition is formulated as an aqueous pre-mix formulation.

In an aspect, the agriculturally acceptable excipient is any or a combination of a surfactant, a preservative, a coloring agent, a pH adjusting agent, anti-foaming agent and a solvent. In an embodiment, the formulation has a pH ranging from 7.5 to 10.5.

Another aspect of the present disclosure provides an aqueous pre-mix agricultural formulation comprising: kasugamycin or a salt thereof in an amount ranging from 0.1% w/v to 40% w/v by weight of the composition; a plant resistance elicitor and an agriculturally acceptable excipient, wherein the weight ratio of kasugamycin or a salt thereof and the plant resistance elicitor is in the range of 1:70 to 5:1.

In an aspect, the formulation comprises kasugamycin or a salt thereof and the plant resistance elicitor in a weight ratio ranging from 1:50 to 2:1.

In an aspect, the formulation comprises kasugamycin or a salt thereof and the plant resistance elicitor in a weight ratio ranging from 1:15 to 1:40.

In another aspect, the plant resistance elicitor includes any or a combination of fulvic acid, salicylic acid, inositol, flavonoids, glucosamine, seaweed extract, a nitrogen source, a potassium source, a sulphur source and a copper source.

In an aspect, the salt of kasugamycin is kasugamycin hydrochloride hydrate.

In an aspect, the nitrogen source is urea.

In an aspect, the potassium source is a potassium salt such as potassium oxide.

In an aspect, the copper source is copper salt such as copper monoglycinate, copper nitrate and copper chloride.

In an aspect, the formulation comprises, by weight, kasugamycin or salt thereof in an amount ranging from 0.1% to 40% w/v, fulvic acid in an amount ranging from 0.5%-35% w/v, salicylic acid in an amount ranging from 0.5%-35% w/v, inositol in an amount ranging from 0.05%-5% w/v, glucosamine in an amount ranging from 0.05%-5.0% w/v, and an excipient in an amount ranging from 5% to 95% w/v, each ingredient by weight of the composition.

In an aspect, the formulation further comprises the nitrogen source in an amount ranging from 0.1%-10% w/v, the potassium source in an amount ranging from 1.0%-25% w/v, the copper source in an amount ranging from 0.05%-5.0% w/v, each ingredient by weight of the composition.

In a further aspect, the present invention provides a method of controlling phytopathogens comprising applying at the locus of the infection by the phytopathogen or to a plant or to a plant part or to a plant propagation material a composition comprising kasugamycin or a salt thereof, and a plant resistance elicitor; wherein the weight ratio of kasugamycin or the salt thereof and a plant resistance elicitor is from 1:1 to 1:40.

Various objects, features, aspects and advantages of the inventive subject matter will become more apparent from the following detailed description of preferred embodiments.

### DETAILED DESCRIPTION OF DRAWINGS

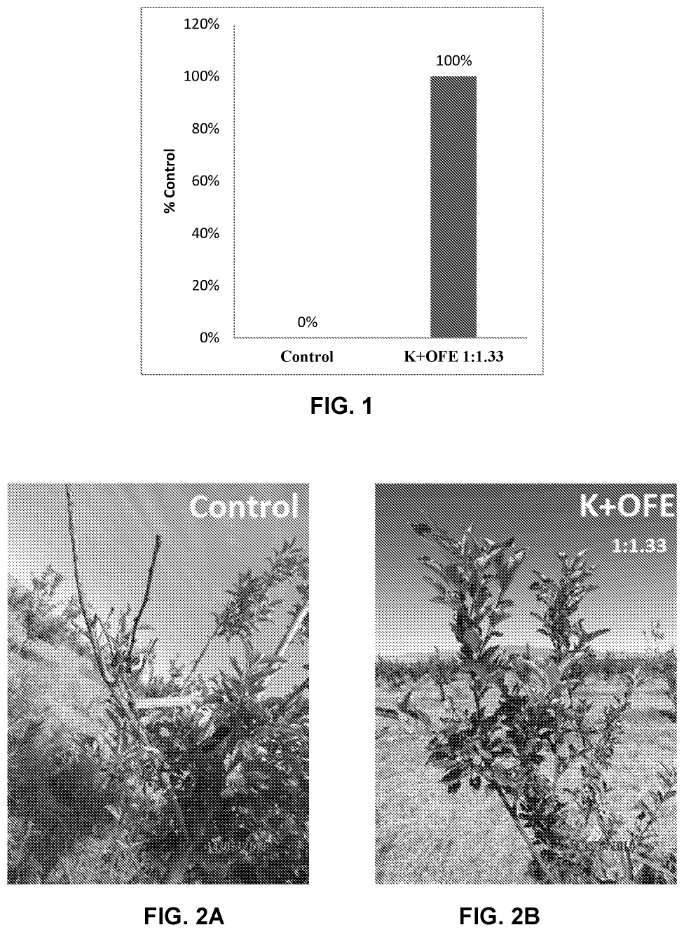

FIG. 1 depicts the control percentage of Erwinia amylovora (K+OFE refers to kasugamycin+organic fertilizer elicitor);

FIG. 2 depicts the effect of the formulation (K+OFE refers to kasugamycin+organic fertilizer elicitor) in comparison to the control (no treatment) as shown in FIGS. 2A and 2B.

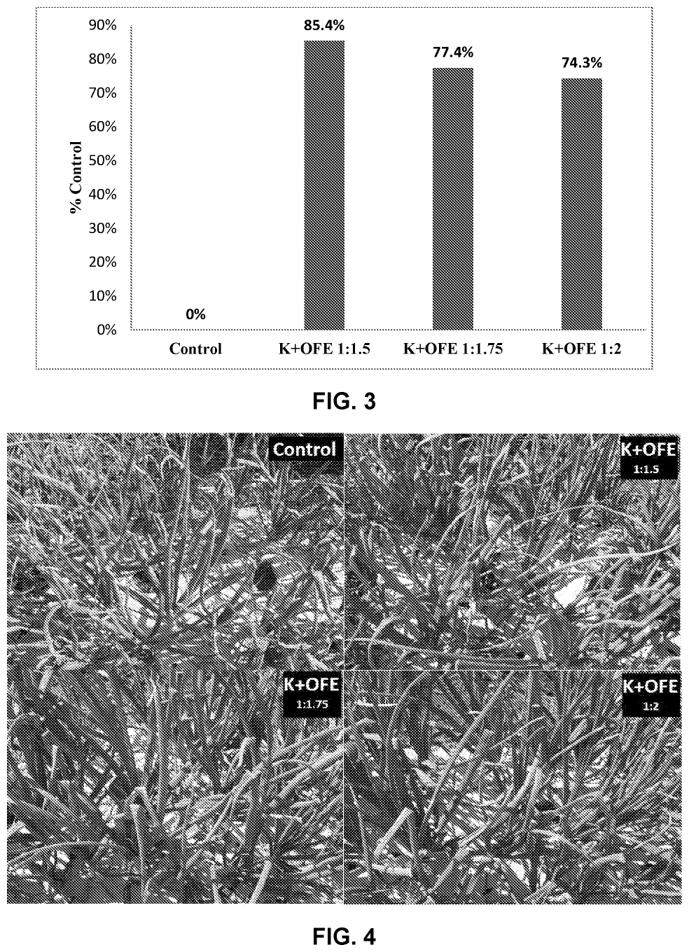

FIG. 3 depicts the Control percentage of Burkholderia gladioli (K+OFE refers to kasugamycin+organic fertilizer elicitor),

FIG. 4 depicts the effect of the formulation, wherein “Control” indicates untreated, “K+OFE 1:1.5” indicates Formulation 1 comprising kasugamycin and the organic fertilizer elicitor, “K+OFE 1:1.75” indicates Formulation 2 comprising kasugamycin and the organic fertilizer elicitor and “K+OFE1:2” indicates Formulation 3 comprising kasugamycin and the organic fertilizer elicitor.

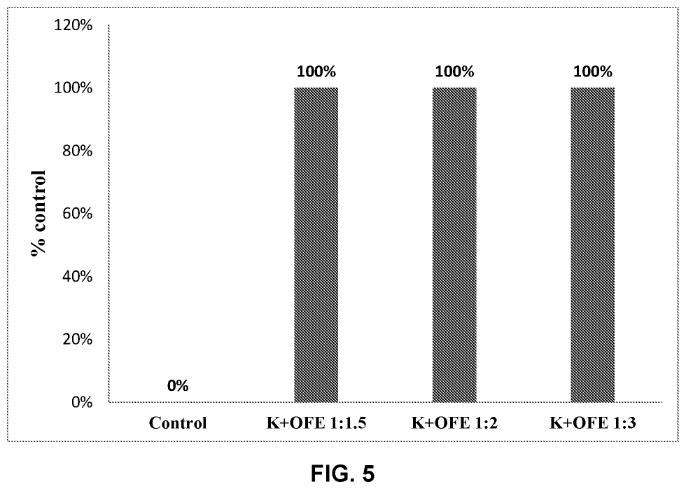

FIG. 5 depicts the control percentage of Ralstonia solanacearum (K+OFE refers to kasugamycin+organic fertilizer elicitor).

### DETAILED DESCRIPTION OF THE INVENTION

The following is a detailed description of embodiments of the present invention. The embodiments are in such detail as to clearly communicate the invention. However, the amount of detail offered is not intended to limit the anticipated variations of embodiments; on the contrary, the intention is to cover all modifications, equivalents, and alternatives falling within the spirit and scope of the present invention as defined by the appended claims.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases, it will be recognized that references to the “invention” will refer to subject matter recited in one or more, but not necessarily all of the claims.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability.

Unless the context requires otherwise, throughout the specification which follow, the word “comprise” and variations thereof, such as, “comprises” and “comprising” are to be construed in an open, inclusive sense that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in the description herein and throughout the claims that follow, the meaning of“a,” “an,” and “the” includes plural reference unless the context clearly dictates otherwise. Also, as used in the description herein, the meaning of “in” includes “in” and “on” unless the context clearly dictates otherwise.

In some embodiments, the numbers expressing quantities of ingredients, properties such as concentration, and so forth, used to describe and claim certain embodiments of the invention are to be understood as being modified in some instances by the term “about.” Accordingly, in some embodiments, the numerical parameters set forth in the written description are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable.

The recitation of ranges of values herein is merely intended to serve as a shorthand method of referring individually to each separate value falling within the range. Unless otherwise indicated herein, each individual value is incorporated into the specification as if it were individually recited herein.

The terms fertilizer elicitor and organic fertilizer elicitor used herein refer to natural or artificial substances containing chemical elements that improve growth and productiveness of plants by eliciting or inducing a defence response in plants to phytopathogenic diseases, by enhancing the natural fertility of the soil and by replacing the chemical elements taken from the soil by previous crops. Therefore, the terms fertilizer elicitor or organic fertilizer elicitor or a plant resistance elicitor have been used interchangeably in the present invention.

“Alkyl” as used herein means a straight or branched chain saturated aliphatic hydrocarbon having the specified number of carbon atoms. Alkyl groups include, for example, groups having from 1 to 50 carbon atoms (C₁ to C₅₀ alkyl).

“Alkylene” means a straight, branched or cyclic divalent aliphatic hydrocarbon group, and may have from 1 to about 18 carbon atoms, more specifically 2 to about 12 carbons. Exemplary alkylene groups include methylene (—CH₂—), ethylene (—CH₂CH₂—), propylene (—(CH₂)₃), cyclohexylene (—C₆H₁₀—), methylenedioxy (—O—CH₂—O—), or ethylenedioxy (—O—(CH₂)₂—O—).

“Aryloxy” means an aryl moiety that is linked via an oxygen (i.e., —O-aryl). An aryloxy group includes a C₆ to C₃₀ aryloxy group, and specifically a C₆ to C₁₈ aryloxy group. Non-limiting examples include phenoxy, naphthyloxy and tetrahydronaphthyloxy.

The headings and abstract of the invention provided herein are for convenience only and do not interpret the scope or meaning of the embodiments.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

Various terms as used herein are shown below. To the extent a term used in a claim is not defined below, it should be given the broadest definition persons in the pertinent art have given that term as reflected in printed publications and issued patents at the time of filing.

The present disclosure relates to agricultural compositions. Particularly, the present disclosure provides an agricultural composition including Kasugamycin or salt thereof and a plant resistance elicitor that exhibits antifungal and antibacterial properties. Further aspects of the present disclosure relate to an aqueous pre-mix agricultural formulation and a method of preparation thereof.

The present disclosure is on the premise of surprising discovery of inventors of the instant application that compositions including kasugamycin or a salt thereof and a plant resistance elicitor exhibits good synergy/functional reciprocity therebetween, aids in reducing dosage of kasugamycin or salt thereof, and consequently aids in reducing or mitigating phytotoxicity. It could also be noted that the compositions may aid in precluding development of resistance of phytopathogens towards kasugamycin or salt thereof.

Accordingly, an aspect of the present disclosure provides an agricultural combination comprising kasugamycin or a salt thereof and plant resistance elicitor compound, wherein kasugamycin or a salt thereof and a plant resistance elicitor is in a weight ratio of 1:1 to 1:70.

In an embodiment, the present disclosure provides an agricultural combination comprising kasugamycin or a salt thereof and a plant resistance elicitor in a weight ratio of 1:1 to 1:40.

In a preferred embodiment, the present disclosure provides an agricultural combination comprising kasugamycin or a salt thereof and a plant resistance elicitor in a weight ratio of 1:1 to 1:30.

In an embodiment, the salt of kasugamycin is kasugamycin hydrochloride hydrate.

In another embodiment, the plant resistance elicitor compound or combinations thereof selected from one or more of metabolites, nutrients and/or seaweed extracts.

In an embodiment, the metabolites are secondary plant metabolites selected from the group comprising fulvic acid, salicylic acid, steroids, saponins flavonoids, phenylpropanoids, lignins, coumarins, lignins, polyacetylenes, terpenes, fatty acids, lectins, polypeptides and waxes.

In a preferred embodiment, the metabolites are secondary plant metabolites selected from the group comprising fulvic acid, flavonoids and salicylic acid.

In an embodiment the flavonoid is selected from anthocyanins, chalcones, flavanones, flavones and isoflavonoids.

In an embodiment the flavonoid is selected from but not limited to quercetin, rutin, macluraxanthone, genistein, scopoletin, daidzein, taxifolin, naringin (naringenin), abyssinones, eriodictyol, peonidin, tricin, biochanin.

In an embodiment, the flavonoid is the naringin flavonoid elicitor.

In an embodiment, the seaweed extract is Ascophyllum nodosum.

In an embodiment, the plant resistance elicitor includes any or a combination comprising fulvic acid, salicylic acid, inositol, flavonoids, glucosamine, a nitrogen source, a potassium source, a sulphur source and a copper source.

In an embodiment, the nutrient sources are selected from carbon, hydrogen, nitrogen, oxygen, phosphorus, potassium, calcium, magnesium, sulfur, boron, chlorine, copper, iron, manganese, molybdenum, zinc, cobalt, nickel, silicon, sodium, and vanadium.

In an embodiment, the nutrient source is selected from a carbon source, a nitrogen source, a potassium source, a sulphur source and a copper source.

The presence of essential elements such as nitrogen (N), potassium (K), and copper (Cu), aids in formation of proteins and carbohydrates, necessary for plant metabolism. Further, K and Cu also aids in reinforcement of cell wall, which aid in developing resistance to pathogen attack. Salicylic acid and glucosamine, the precursors of synthesis of secondary metabolites and proteins with enzymatic activity, also improves the self-defence function of plants against establishment and growth of phytopathogenic microorganisms. Inositol and fulvic acid aid in regulating endogenous hormonal activity in plants, controlling cell growth and inhibiting ethylene synthesis, and consequently, preserving the freshness of plant cells. Accordingly, the plant resistance elicitor exhibits functional reciprocity with the kasugamycin or a salt thereof, aiding in reduction of dosage of kasugamycin or a salt thereof.

In a preferred embodiment, the plant resistance elicitor includes one or a combination comprising fulvic acid, salicylic acid, inositol, flavonoids, glucosamine, seaweed extract, a nitrogen source, a potassium source, a sulphur source and a copper source.

Accordingly, an aspect of the present disclosure provides an agricultural composition, said composition comprising: an agriculturally effective amount of kasugamycin or a salt thereof, an agriculturally effective amount of a plant resistance elicitor and an agriculturally acceptable excipient, wherein kasugamycin or a salt thereof and a plant resistance elicitor is in a weight ratio of 1:1 to 1:70.

In a preferred embodiment, the present disclosure provides an agricultural composition, comprising an agriculturally effective amount of kasugamycin or a salt thereof; an agriculturally effective amount of a plant resistance elicitor and an agriculturally acceptable excipient, wherein kasugamycin or a salt thereof and a plant resistance elicitor is in a weight ratio of 1:1 to 1:50.

In an embodiment, the composition comprises kasugamycin or a salt thereof and the plant resistance elicitor in a weight ratio ranging from 1:70 to 5:1.

In an embodiment, the composition comprises kasugamycin or a salt thereof and the plant resistance elicitor in a weight ratio ranging from 1:50 to 2:1.

In an embodiment, the composition comprises kasugamycin or a salt thereof and the plant resistance elicitor in a weight ratio ranging from 1:5 to 1:50.

In an embodiment, the composition comprises kasugamycin or a salt thereof and the plant resistance elicitor in a weight ratio ranging from 1:1 to 1:40.

In an embodiment, the composition comprises kasugamycin or a salt thereof and the plant resistance elicitor in a weight ratio ranging from 1:1 to 1:30.

In an embodiment, the salt of kasugamycin is kasugamycin hydrochloride hydrate.

In an embodiment, the plant resistance elicitor compound or combinations thereof are selected from one or more of metabolites, nutrients and/or seaweed extracts.

In an embodiment, the metabolites are secondary plant metabolites selected from the group comprising fulvic acid, salicylic acid, steroids, saponins flavonoids, phenylpropanoids, lignins, coumarins, lignins, polyacetylenes, terpenes, fatty acids, lectins, polypeptides and waxes.

In a preferred embodiment, the metabolites are selected from the group comprising fulvic acid, flavonoids and salicylic acid.

In an embodiment the flavonoid is selected from anthocyanins, chalcones, flavanones, flavones and isoflavonoids.

In an embodiment the flavonoid is selected from but not limited to quercetin, rutin, macluraxanthone, genistein, scopoletin, daidzein, taxifolin, naringin (naringenin), abyssinones, eriodictyol, peonidin, tricin, biochanin.

In an embodiment, the flavonoid is the naringin flavonoid elicitor.

In an embodiment, the seaweed extract is Ascophyllum nodosum.

In an embodiment, the plant resistance elicitor includes any or a combination comprising fulvic acid, salicylic acid, inositol, flavonoids, glucosamine, a nitrogen source, a potassium source, a sulphur source and a copper source.

In an embodiment, the nutrient source is selected from one or more of carbon, hydrogen, nitrogen, oxygen, phosphorus, potassium, calcium, magnesium, sulfur, boron, chlorine, copper, iron, manganese, molybdenum, zinc, cobalt, nickel, silicon, sodium, and vanadium.

In an embodiment, the nutrient source is selected from one or more of carbon source, a nitrogen source, a potassium source, a sulphur source and a copper source.

In a preferred embodiment, the plant resistance elicitor includes one or a combination comprising fulvic acid, salicylic acid, inositol, flavonoids, glucosamine, seaweed extract, a nitrogen source, a potassium source, a sulphur source and a copper source.

In an embodiment, the composition comprises kasugamycin or a salt thereof in an amount ranging from 0.1% to 40% (w/v) by weight of the composition.

In an embodiment, the composition comprises kasugamycin or a salt thereof in an amount ranging from 1% to 30% (w/v) by weight of the composition.

In a preferred embodiment, the composition comprises kasugamycin or a salt thereof in an amount ranging from 1% to 10% (w/v) by weight of the composition.

In an embodiment, the composition comprises the plant elicitor compound or combinations thereof in amount ranging from 5% to 70% (w/v) by weight of the composition.

In an embodiment, the composition comprises the plant elicitor compound or combinations thereof in amount ranging from 10% to 60% (w/v) by weight of the composition.

In a preferred embodiment, the composition comprises the plant elicitor compound or combinations thereof in amount ranging from 15% to 50% (w/v) by weight of the composition.

In an embodiment, the composition comprises the plant elicitor compound or combinations thereof comprising metabolites in an amount ranging from 0.5%-40% (w/v), a nutrient source in an amount ranging from 0.05%-15% (w/v) and a sea-weed extract in an amount ranging from 0.01%-10% (w/v), each ingredient by weight of the composition.

In an embodiment, the composition comprises the plant elicitor compound or combinations thereof comprising metabolites in an amount ranging from 0.5%-40% (w/v) and a nutrient source in an amount ranging from 0.05%-15% (w/v), each ingredient by weight of the composition.

In a preferred embodiment, the composition comprises the plant elicitor compound or combinations thereof comprising metabolites in an amount ranging from 1%-30% (w/v) and a nutrient source in an amount ranging from 0.05%-15% (w/v), each ingredient by weight of the composition.

In a preferred embodiment, the composition comprises the plant elicitor compound or combinations thereof comprising metabolites in an amount ranging from 5%-20% (w/v) and a nutrient source in an amount ranging from 1%-15% (w/v), each ingredient by weight of the composition.

In an embodiment, the composition comprises kasugamycin or a salt thereof in an amount ranging from 0.1% to 40% (w/v), metabolites in an amount ranging from 0.5%-40% (w/v), a nutrient source in an amount ranging from 0.05%-15% (w/v) and an excipient in an amount ranging from 5% to 95% (w/v), each ingredient by weight of the composition.

In a preferred embodiment, the composition comprises kasugamycin or a salt thereof in an amount ranging from 0.1% to 30% (w/v), metabolites in an amount ranging from 5%-20% (w/v), a nutrient source in an amount ranging from 1%-15% (w/v) and an excipient in an amount ranging from 5% to 95% (w/v), each ingredient by weight of the composition.

In an embodiment, the composition comprises kasugamycin or a salt thereof in an amount ranging from 0.1% to 40% (w/v), metabolites in an amount ranging from 0.5%-35% (w/v), a sea-weed extract in an amount ranging from 0.01%-10% (w/v), a nutrient source in an amount ranging from 0.05%-15% (w/v) and an excipient in an amount ranging from 5% to 95% (w/v), each ingredient by weight of the composition.

In an embodiment, the composition comprises kasugamycin or a salt thereof in an amount ranging from 0.1% to 40% (w/v), fulvic acid in an amount ranging from 0.5%-35% (w/v), salicylic acid in an amount ranging from 0.5%-35% (w/v), inositol in an amount ranging from 0.05%-5% (w/v), glucosamine in an amount ranging from 0.05%-5.0% (w/v), and an excipient in an amount ranging from 5% to 95% (w/v), each ingredient by weight of the composition.

In an embodiment, the composition further comprises the nitrogen source in an amount ranging from 0.1%-10% w/v, the potassium source in an amount ranging from 1.0%-25% w/v, the copper source in an amount ranging from 0.05%-5.0% w/v, each ingredient by weight of the composition.

In an embodiment, the composition exhibits wide spectrum antifungal and antibacterial properties. Particularly, the composition of the present disclosure is effective against Erwinia amylovora, Ralstonia solanacearum, Burkholderia gladioli, Alternaria alternata, Xanthomonas spp, Erwinia carotovora, Pyricularia oryzae, Xanthomonas axonopodispv. Vesicatoria, Burkholderia andropogonis, and Streptomyces scabies.

In an embodiment, the salt of kasugamycin is kasugamycin hydrochloride hydrate.

In an embodiment, the nitrogen source is urea.

In an embodiment, the carbon source is selected from sugars such as inositol, glucosamine, chitosan, chitin.

In an embodiment, the potassium source is a potassium salt such as potassium oxide.

In an embodiment, the copper source is copper salt such as copper glycinate, copper monoglycinate, copper nitrate, copper chloride, copper oxychloride, copper hydroxide, copper sulphate, tribasic copper sulphate.

In an embodiment, the sulphur source is sulphates, sulfonyl compounds.

In an embodiment, the sulphur source is methyl sulfonyl methane.

In an embodiment, the agriculturally acceptable excipient includes any or a combination comprising wetting agent, dispersing agent, binding agent, surfactant/emulsifier, anti-foaming agent, anti-freezing agent, mineral, filler, preservative, coloring agent, and pH adjusting agent. However, it should be appreciated that any other agriculturally acceptable excipients, as known to a person skilled in the art, may be used to serve its intended purpose. In an embodiment, the agriculturally acceptable excipients are present in an amount ranging from 5% to 99% by weight of the composition.

The wetting agent may include any or a combination comprising sulfosuccinates, naphthalene sulfonates, sulfated esters, phosphate esters, sulfated alcohol and alkyl benzene sulfonates, but not limited thereto.

The dispersing agent may include any or a combination comprising polycarboxylates, naphthalene sulfonate condensates, phenol sulfonic acid condensates, lignosulfonates, methyl oleyl taurates and polyvinyl alcohols, but not limited thereto.

The binding agent may include any or a combination comprising polyvinyl alcohols, phenyl naphthalene sulphonate, lignin derivatives, polyvinyl pyrrolidone, polyalkylpyrrolidone, carboxymethylcellulose, xanthan gum, polyethoxylated fatty acids, polyethoxylated fatty alcohols, ethylene oxide copolymer, propylene oxide copolymer, polyethylene glycols and polyethylene oxides, but not limited thereto.

The surfactant may include any or a combination comprising ionic surfactants and non-ionic surfactants. Non-limiting examples of ionic surfactants include sulfonic acids, sulfuric acid esters, carboxylic acids, and salts thereof. Non-limiting examples of water soluble anionic surfactants include alkyl sulfates, alkyl ether sulfates, alkyl amido ether sulfates, alkyl aryl polyether sulfates, alkyl aryl sulfates, alkyl aryl sulfonates, monoglyceride sulfates, alkyl sulfonates, alkyl amide sulfonates, alkyl aryl sulfonates, benzene sulfonates, toluene sulfonates, xylene sulfonates, cumene sulfonates, alkyl benzene sulfonates, alkyl diphenyloxide sulfonate, alpha-olefin sulfonates, alkyl naphthalene sulfonates, paraffin sulfonates, lignin sulfonates, alkyl sulfosuccinates, ethoxylated sulfosuccinates, alkyl ether sulfosuccinates, alkylamide sulfosuccinates, alkyl sulfosuccinamate, alkyl sulfoacetates, alkyl phosphates, phosphate ester, alkyl ether phosphates, acyl sarconsinates, acyl isethionates, N-acyl taurates, N-acyl-N-alkyltaurates, and alkyl carboxylates. Non-limiting examples of the non-ionic surfactants include glycerol ethers, glycol ethers, ethanolamides, sulfoanylamides, alcohols, amides, alcohol ethoxylates, glycerol esters, glycol esters, ethoxylates of glycerol ester and glycol esters, sugar-based alkyl polyglycosides, polyoxyethylenated fatty acids, alkanolamine condensates, alkanolamides, tertiary acetylenic glycols, polyoxyethylenated mercaptans, carboxylic acid esters, polyoxyethylenated polyoxyproylene glycols, sorbitan fatty esters, or combinations thereof. Also included are EO/PO block copolymers (EO is ethylene oxide, PO is propylene oxide), EO polymers and copolymers, polyamines, and polyvinylpynolidones, sorbitan fatty acid alcohol ethoxylates and sorbitan fatty acid ester ethoxylates.

The anti-freezing agents may include any or a combination of ethylene glycol, propylene glycol, urea, glycerin and anti-freeze proteins, but not limited thereto.

The minerals may include any or a combination of kaolin, silica, titanium (IV) oxide, rutile, anatase, aluminum oxides, aluminum hydroxides, iron oxide, iron sulfide, magnetite, pyrite, hematite, ferrite, gregite, calcium carbonate, calcite, aragonite, quartz, zircon, olivine, orthopyroxene, tourmaline, kyanite, albite, anorthite, clinopyroxene, orthoclase, gypsum, andalusite, talc, fluorite, apatite, orthoclase, topaz, corundum, diamond, tin, tin oxides, antimony, antimony oxides, beryllium, cobalt, copper, feldspar, gallium, indium, lead, lithium, manganese, mica, molybdenum, nickel, perlite, platinum group metals, phosphorus and phosphate rock, potash, rare earth elements, tantalum, tungsten, vanadium, zeolites, zinc and zinc oxide, and indium tin oxide, but not limited thereto.

The fillers may include any or a combination of diatomaceous earth, kaolin, bentonite, precipitated silica, attapulgite, and perlite, but not limited thereto.

The advantageous agricultural compositions of the present disclosure can be formulated in any of formulations such as aqueous formulation, aerosol, emulsifiable concentrate, wettable powder, soluble concentrate, soluble powder, suspension concentrate, spray concentrate, capsule suspension, water dispersible granule, granules, dusts, microgranule seed treatment formulation and the likes as known to persons skilled in the art.

In an embodiment, the agricultural composition is formulated as a liquid formulation.

In an embodiment, the composition is formulated as an aqueous pre-mix formulation. In an embodiment, the agriculturally acceptable excipient is any or a combination of a surfactant, a preservative, a coloring agent, a pH adjusting agent, anti-foaming agent and a solvent. In an embodiment, the formulation has a pH ranging from 7.5 to 10.5.

Another aspect of the present disclosure provides an aqueous pre-mix agricultural formulation, said formulation comprising kasugamycin or salt thereof in an amount ranging from 0.1% to 40% by weight of the composition; a plant resistance elicitor; and an agriculturally acceptable excipient, wherein the weight ratio of kasugamycin or salt thereof and the plant resistance elicitor is in the range of 1:70 to 5:1.

In an embodiment, the formulation comprises kasugamycin or salt thereof and the plant resistance elicitor in a weight ratio ranging from 1:50 to 2:1. In another embodiment, the formulation comprises kasugamycin or salt thereof and the plant resistance elicitor in a weight ratio ranging from 1:15 to 1:40.

In an embodiment, the plant resistance elicitor includes any or a combination of fulvic acid, salicylic acid, inositol, flavonoids, glucosamine, seaweed extract, a nitrogen source, a potassium source, and a copper source.

In an embodiment, the salt of kasugamycin is kasugamycin hydrochloride hydrate.

In an embodiment, the nitrogen source is urea.

In an embodiment, the potassium source is a potassium salt such as potassium oxide.

In an embodiment, the copper source is copper salt such as copper sulphate, tribasic copper sulphate, copper glycinate, copper monoglycinate, copper hydroxide, copper nitrate, copper oxychloride and copper chloride.

In an embodiment, the sulphur source is methyl sulfonyl methane.

In an embodiment, the formulation comprises, by weight, kasugamycin or a salt thereof in an amount ranging from 0.1% to 40% w/v, fulvic acid in an amount ranging from 0.5%-35% w/v, salicylic acid in an amount ranging from 0.5%-35% w/v, inositol in an amount ranging from 0.05%-5% w/v, glucosamine in an amount ranging from 0.05%-5.0% w/v, and an excipient in an amount ranging from 5% to 95% w/v. In an embodiment, the formulation further comprises the nitrogen source in an amount ranging from 0.1%-10% w/v, the potassium source in an amount ranging from 1.0%-25% w/v, the copper source in an amount ranging from 0.05%-5.0% w/v.

The agricultural benefit may be accrued by treating a seed, a plant, a plant part, a soil, or a combination thereof, with a composition or formulation of the present disclosure under conditions leading to association between the composition and the seed, plant, plant part, soil, or combinations thereof. Application of a formulation to a target can be accomplished using any delivery method known in the art including, but not limited to dusting, fumigation, granule application, injection, misting, seed treatment, spraying, dipping, or coating.

In an embodiment the present compositions further comprising an herbicide, fungicide, insecticide, nematicide, acaricides or combinations thereof.

In an embodiment the insecticide may be selected from group of Acetylcholinesterase (AChE) inhibitors, GABA-gated chloride channel blockers, Sodium channel modulators, Nicotinic acetylcholine receptor (nAChR) competitive modulators, Nicotinic acetylcholine receptor (nAChR) allosteric modulators—Site I, Glutamate-gated chloride channel (GluCl) allosteric modulators, Juvenile hormone mimics, miscellaneous nonspecific (multi-site) inhibitors, Chordotonal organ TRPV channel modulators, Mite growth inhibitors affecting CHS1, Microbial disruptors of insect midgut membranes, Inhibitors of mitochondrial ATP synthase, Uncouplers of oxidative phosphorylation via disruption of the proton gradient, Nicotinic acetylcholine receptor (nAChR) channel blockers, Inhibitors of chitin biosynthesis affecting CHS1. Inhibitors of chitin biosynthesis, Moulting disruptors, Dipteran, Ecdysone receptor agonists, Octopamine receptor agonists, Mitochondrial complex III electron transport inhibitors, Mitochondrial complex I electron transport inhibitors, Voltage-dependent sodium channel blockers, Inhibitors of acetyl CoA carboxylase, Mitochondrial complex IV electron transport inhibitors, Mitochondrial complex II electron transport inhibitors, Ryanodine receptor modulators, Chordotonal organ Modulators—undefined target site, GABA-gated chloride channel allosteric modulators and Baculoviruses.

In an embodiment, the fungicide may be selected from nucleic acid synthesis inhibitors, cytoskeleton and motor protein inhibitors, amino acids and protein synthesis inhibitors, respiration process inhibitors, signal transduction inhibitors, lipid synthesis or transport and membrane integrity disruptors or functions, sterol biosynthesis inhibitors, melanin synthesis inhibitors, cell wall biosynthesis inhibitors, melanin synthesis inhibitor in cell wall, host plant defence inductors, fungicides with unknown modes of action, non-classified fungicides, fungicides with multisite activity and/or biologicals with multiple mode of action.

In an embodiment, the herbicide may be selected from a isoxazolidinone herbicide, a urea herbicide, a triazine herbicide, a hydroxybenzonitrile herbicide, a thiocarbamate herbicide, a pyridazine herbicide, chloroacetanilide herbicides; benzothiazole herbicides; carbanilate herbicides, cyclohexene oxime herbicides; picolinic acid herbicides; pyridine herbicides; quinolinecarboxylic acid herbicides; chlorotriazine herbicides, aryloxyphenoxypropionic herbicides, oxadiazolone herbicides; phenylurea herbicides, sulfonanilide herbicides; triazolopyrimidine herbicides, amide herbicides, pyridazine herbicides, dinitroaniline herbicides or combinations thereof.

The combinations of the present disclosure provide an agricultural composition as a pre-mix composition or a kit of parts such that individual actives may be mixed before spraying. Alternatively, the kit of parts may contain the kasugamycin or a salt thereof and the plant elicitor compound mixture, pre-mixed and an optional third active may be admixed with an adjuvant or an agrochemical or a fertilizer compound such that the two components may be tank mixed before spraying.

In an embodiment, the present disclosure provides a kit-of-parts comprising an agricultural combination of kasugamycin or a salt thereof, and a plant resistance elicitor compound.

In an embodiment, the present disclosure provides a kit-of-parts comprising an agricultural combination of kasugamycin or a salt thereof and a plant elicitor compound mixture comprising metabolites, a seaweed extract and a nutrient source.

In an embodiment, the plant resistance elicitor includes one or a combination comprising fulvic acid, salicylic acid, inositol, flavonoids, glucosamine, seaweed extract, a nitrogen source, a potassium source, a sulphur source and a copper source.

In an embodiment, the present invention provides the use of the agricultural composition comprising kasugamycin or a salt thereof and a plant resistance elicitor in a weight ratio of 1:1 to 1:50 for controlling phytopathogens.

The method of the present disclosure may be used to control a broad spectrum of plant diseases.

Diseases in rice include blast (Magnaporthe grisea), Helminthosporium leaf spot (Cochliobolus miyabeanus), sheath blight (Rhizoctonia solani), and bakanae disease (Gibberella fujikuroi).

Diseases in wheat include powdery mildew (Erysiphe graminis), Fusariuin head blight (Fusarium graminearum, F. avenacerum, F. culmorum, Microdochium nivale), rust (Puccinia strilformis, P. graminis, P. recondita), pink snow mold (Micronectriella nivale), Typhula snow blight (Typhula sp.), loose smut (Ustilago tritici), bunt (Tilletia caries), eyespot (Pseudocercosporella herpotrichoides), leaf blotch (Mycosphaerella graminicola), glume blotch (Stagonospora nodorum), septoria, and yellow spot (Pyrenophora tritici-repentis).

Diseases of barley include powdery mildew (Erysiphe graminis), Fusarium head blight (Fusarium graminearum, F. avenacerum, F. culmorum, Microdochium nivale), rust (Puccinia strilformis, P. graminis, P. hordei), loose smut (Ustilago nuda), scald (Rhynchosporium secalis), net blotch (Pyrenophora teres), spot blotch (Cochiobolus sativus), leaf stripe (Pyrenophora graminea), and Rhizoctonia damping-off (Rhizoctonia solani).

Diseases in corn include smut (Ustilago maydis), brown spot (Cochliobolus heterostrophus), copper spot (Gloeocercospora sorghi), southern rust (Puccinia polysora), gray leaf spot (Cercospora zeae-maydis), white spot (Phaeosphaeria mydis and/or Pantoea ananatis), and Rhizoctonia damping-off (Rhizoctonia solani).

Diseases of citrus include melanose (Diaporthe citri), scab (Elsinoe fawcetti), penicillium rot (Penicillium digitatum, P. italicum), and brown rot (Phytophthora parasitica, Phytophthora citrophthora).

Diseases of apple include blossom blight (Monilinia mali), canker (Valsa ceratosperma), powdery mildew (Podosphaera leucotricha), Alternaria leaf spot (Alternaria alternata apple pathotype), scab (Venturia inaequalis), powdery mildew, bitter rot (Colletotrichum acutatum), crown rot (Phytophtora cactorum), blotch (Diplocarpon mali), and ring rot (Botryosphaeria berengeriana).

Diseases of pear include scab (Venturia nashicola, V. pirina), powdery mildew, black spot (Alternaria alternata Japanese pear pathotype), rust (Gymnosporangium haraeanum), and phytophthora fruit rot (Phytophtora cactorum).

Diseases of peach include brown rot (Monilinia fructicola), powdery mildew, scab (Cladosporium carpophilum), and phomopsis rot (Phomopsis sp.).

Diseases of grape include anthracnose (Elsinoe ampelina), ripe rot (Glomerella cingulata), powdery mildew (Uncinula necator), rust (Phakopsora ampelopsidis), black rot (Guignardia bidwellii), botrytis, and downy mildew (Plasmopara viticola).

Diseases of Japanese persimmon include anthracnose (Gloeosporium kaki), and leaf spot (Cercospora kaki, Mycosphaerella nawae).

Diseases of gourd include anthracnose (Colletotrichum lagenarium), powdery mildew (Sphaerotheca fuliginea), gummy stem blight (Mycosphaerella melonis), Fusarium wilt (Fusarium oxysporum), downy mildew (Pseudoperonospora cubensis), Phytophthora rot (Phytophthora sp.), and damping-off (Pythium sp.).

Diseases of tomato include early blight (Alternaria solani), leaf mold (Cladosporium fulvum), and late blight (Phytophthora infestans).

Diseases of eggplant include brown spot (Phomopsis vexans), and powdery mildew (Erysiphe cichoracearum)

Diseases of cruciferous vegetables include Alternaria leaf spot (Alternaria japonica), white spot (Cercosporella brassicae), clubroot (Plasmodiophora brassicae), and downy mildew (Peronospora parasitica).

Diseases of onion include rust (Puccinia allii), and downy mildew (Peronospora destructor)

Diseases of soybean include purple seed stain (Cercospora kikuchii), sphaceloma scad (Elsinoe glycines), pod and stem blight (Diaporthe phaseolorum var. sojae), septoria brown spot (Septoria glycines), frogeye leaf spot (Cercospora sojina), rust (Phakopsora pachyrhizi), Yellow rust, brown stem rot (Phytophthora sojae), and Rhizoctonia damping-off (Rhizoctonia solani).

Diseases of kidney bean include anthracnose (Colletotrichum lindemthianum).

Diseases of peanut include leaf spot (Cercospora personata), brown leaf spot (Cercospora arachidicola) and southern blight (Sclerotium rolfsii).

Diseases of garden pea include powdery mildew (Erysiphe pisi), and root rot (Fusarium solani f sp. pisi).

Diseases of potato include early blight (Alternaria solani), late blight (Phytophthora infestans), pink rot (Phytophthora erythroseptica), and powdery scab (Spongospora subterranean f. sp. subterranea).

Diseases of strawberry include powdery mildew (Sphaerotheca humuli), and anthracnose (Glomerella cingulata).

Diseases of tea include net blister blight (Exobasidium reticulatum), white scab (Elsinoe leucospila), gray blight (Pestalotiopsis sp.), and anthracnose (Colletotrichum theae-sinensis).

Diseases of tobacco include brown spot (Alternaria longipes), powdery mildew (Erysiphe cichoracearum), anthracnose (Colletotrichum tabacum), downy mildew (Peronospora tabacina), and black shank (Phytophthora nicotianae).

Diseases of rapeseed include sclerotinia rot (Sclerotinia sclerotiorum), and Rhizoctonia damping-off (Rhizoctonia solani).

Diseases of cotton include Rhizoctonia damping-off (Rhizoctonia solani).

Diseases of sugar beet include Cercospora leaf spot (Cercospora beticola), leaf blight (Thanatephorus cucumeris), root rot (Thanatephorus cucumeris), and Aphanomyces root rot (Aphanomyces cochlioides).

Diseases of rose include black spot (Diplocarpon rosae), powdery mildew (Sphaerotheca pannosa), and downy mildew (Peronospora sparsa).

Diseases of chrysanthemum and asteraceous plants include downy mildew (Bremia lactucae), leaf blight (Septoria chrysanthemi-indici), and white rust (Puccinia horiana).

Diseases of various groups include diseases caused by Pythium spp. (Pythium aphanidermatum, Pythium debarianum, Pythium graminicola, Pythium irregulare, Pythium ultimum), gray mold. (Botrytis cinerea), and Sclerotinia rot (Sclerotinia sclerotiorum).

Disease of Japanese radish include Alternaria leaf spot (Alternaria brassicicola).

Diseases of turfgrass include dollar spot (Sclerotinia homeocarpa), and brown patch and large patch (Rhizoctonia solani).

Disease of banana include black sigatoka (Mycosphaerella frjiensis), and yellow sigatoka (Mycosphaerella musicola).

Disease of sunflower include downy mildew (Plasmopara halstedii).

Seed diseases or diseases in the early stages of the growth of various plants may be caused by Aspergillus spp., Penicillium spp., Fusarium spp., Gibberella spp., Tricoderma spp., Thielaviopsis spp., Rhizopus spp., Mucor spp., Corticium spp., Phoma spp., Rhizoctonia spp. and Diplodia spp.

Viral diseases of various plants may be mediated by Polymyxa spp. or Olpidium spp. and so on.

Most plant pathogenic bacteria belong to the following genera: Erwinia, Pectobacterium, Pantoea, Agrobacterium, Pseudomonas, Ralstonia, Burkholderia, Acidovorax, Xanthomonas, Clavibacter, Streptomyces, Xylella, Spiroplasma, and Phytoplasma.

Particularly, the composition of the present disclosure is effective against Pseudomonas syringae, Xanthomonas spp., Erwinia amylovora, Erwinia carotovora, Pyricularia oryzae, Xanthomonas axonopodispv. Vesicatoria, Burkholderia andropogonis, and Streptomyces scabies.

Examples of the crops on which the present compositions may be used include, are not limited to, corn, rice, wheat, barley, rye, oat, sorghum, cotton, soybean, peanut, buckwheat, beet, rapeseed, sunflower, sugar cane, tobacco, etc.; vegetables: solanaceous vegetables such as eggplant, tomato, pimento, pepper, potato, etc., cucurbit vegetables such as cucumber, pumpkin, zucchini, water melon, melon, squash, etc., cruciferous vegetables such as radish, white turnip, horseradish, kohlrabi, Chinese cabbage, cabbage, leaf mustard, broccoli, cauliflower, etc., asteraceous vegetables such as burdock, crown daisy, artichoke, lettuce, etc, liliaceous vegetables such as green onion, onion, garlic, and asparagus, ammiaceous vegetables such as carrot, parsley, celery, parsnip, etc., chenopodiaceous vegetables such as spinach, Swiss chard, etc., lamiaceous vegetables such as Perilla frutescens, mint, basil, etc, strawberry, sweet potato, Dioscorea japonica, colocasia, etc., flowers, foliage plants, turf grasses, fruits: pome fruits such apple, pear, quince, etc, stone fleshy fruits such as peach, plum, nectarine, Prunus mume, cherry fruit, apricot, prune, etc., citrus fruits such as orange, lemon, rime, grapefruit, etc., nuts such as chestnuts, walnuts, hazelnuts, almond, pistachio, cashew nuts, macadamia nuts, etc. berries such as blueberry, cranberry, blackberry, raspberry, etc., grape, kaki fruit, olive, plum, banana, coffee, date palm, coconuts, etc., trees other than fruit trees; tea, mulberry, flowering plant, trees such as ash, birch, dogwood, Eucalyptus, Ginkgo biloba, lilac, maple, Quercus, poplar, Judas tree, Liquidambar formosana, plane tree, zelkova, Japanese arborvitae, fir wood, hemlock, juniper, Pinus, Picea, and Taxus cuspidate, etc.

In an embodiment, the present disclosure provides a process for the preparation of the agricultural combination comprising kasugamycin or salt thereof and the plant resistance elicitor in a weight ratio ranging from 1:1 to 1:50, wherein the said process comprises mixing kasugamycin or salt thereof and the plant resistance elicitor or combinations thereof in the said ratio.

In an embodiment, the present disclosure provides a process for the preparation of the agricultural composition comprising kasugamycin or a salt thereof and the plant resistance elicitor or combinations thereof in a weight ratio ranging from 1:1 to 1:50, wherein the said process comprises mixing kasugamycin or salt thereof and the plant resistance elicitor compound or combinations thereof in the said ratio.

In a further embodiment, the method of controlling phytopathogens comprises applying at the locus of the infection by the phytopathogen or to a plant or to a plant part or to a plant propagation material a composition comprising kasugamycin or a salt thereof, and a plant resistance elicitor; wherein the weight ratio of kasugamycin or the salt thereof and a plant resistance elicitor is from 1:1 to 1:40.

In one embodiment, the method of controlling phytopathogens comprises applying at the locus of the infection by the phytopathogen or to a plant or to a plant part or to a plant propagation material a composition comprising kasugamycin or a salt thereof, and a plant resistance elicitor; wherein the weight ratio of kasugamycin or the salt thereof and a plant resistance elicitor is from 1:1 to 1:30.

In one embodiment, the method of controlling phytopathogens comprises applying at the locus of the infection by the phytopathogen or to a plant or to a plant part or to a plant propagation material a composition comprising kasugamycin or a salt thereof, and a plant resistance elicitor comprising metabolites, nutrients and a seaweed extract; wherein the weight ratio of kasugamycin or the salt thereof and a plant resistance elicitor is from 1:1 to 1:30.

While the foregoing description discloses various embodiments of the disclosure, other and further embodiments of the invention may be devised without departing from the basic scope of the disclosure. The invention is not limited to the described embodiments, versions or examples, which are included to enable a person having ordinary skill in the art to make and use the invention when combined with information and knowledge available to the person having ordinary skill in the art.

### EXAMPLES

### Example 1—Pre-Mix Formulation

A pre-mix formulation having composition as shown in Table 1 below was prepared:

TABLE 1
Aqueous Pre-mix Formulation

| | Amount |
|---|---|
| Ingredient | (wt. %) |
| Kasugamycin hydrochloride hydrate | 1.08% |
| | (equivalent to Kasugamycin - 0.9%) |
| Fulvic acid | 7.0% |
| Salicylic acid | 6.9% |
| Inositol | 0.35% |
| Glucosamine | 0.2% |
| Potassium oxide (K₂O) | 3.87% |
| Urea | 2.01% |
| Seaweed extract | 2.01% |
| Methyl sulfonyl methane | 0.67% |
| Anti-foaming agent: | 0.03% |
| polydimethylsiloxane | |
| Flavonoids (naringin: citric | 0.09% |
| flavonoid elicitor) | |
| Water | qs |

1000 litres of aqueous pre-mix formulation was prepared with the composition as shown in Table 1 above. For preparation of the formulation, about 500 litres of water was taken in a mixing tank and kasugamycin hydrochloride hydrate was added thereto with stirring till the kasugamycin hydrochloride hydrate was completely dissolved. Plant resistance elicitor was prepared by adding 40% potassium hydroxide, fulvic acid and salicylic acid to 100 ml of water, until completely dissolved. The anti-foaming agent polydimethylsiloxane is gradually added while stirring, verifying that the pH is between 7.5 and 8, adjust with potassium hydroxide. Copper sulphate is dissolved in 40 ml of water and the mixture of fulvic acid and salicylic acid is added. The flavonoid—naringin is dissolved in 50 ml of water with 3 g of potassium hydroxide, and sieved through a 200 mesh, and added to the above mixture. Methyl sulfonyl methane (MSM) is dissolved in 40 ml of water and added to the mixture. Glucosamine is dissolved in 20 ml of water and added. Urea, inositol, anti-foaming, and the seaweed extract are added. The volume of the plant resistance elicitor mixture is completed to 1 L with water. Plant resistance elicitor was added to the solution above along with an amount of water to make up the volume to 1000 litres. pH of the formulation was adjusted to about 8.0. The formulation was then filtered and filled in bottles.

### Efficacy Studies

### Example 2: Foliar Application of Kasugamycin and Plant Resistance Elicitor in Apple Trees (Var. Gala) for Controlling Erwinia amylovora

Apple trees (var. Gala) were foliar sprayed with formulations having Kasugamycin and plant resistance elicitor. Formulation of Kasugamycin and plant resistance elicitor was applied at a dosage of −0.9 g/kg of Kasugamycin (1.08 g/kg of Kasugamycin hydrochloride hydrate), 6.9 g/kg of Salicylic acid, 0.35 g/kg of inositol, 7 g/kg of fulvic acid, 0.2 g/kg of glucosamine, 1.2 g/kg of nitrogen, 0.06 g/kg of copper and 3.87 g/kg of K₂O. Three applications were made every 7 days when the first symptoms of the disease appeared, and the % control of Erwinia amylovora was determined. Control percentage of Erwinia amylovora are illustrated in form of a graph in FIG. 1. Effect of the formulation (K+OFE) in comparison to the control (no treatment) is shown in FIGS. 2A and 2B.

### Example 3: Foliar Application of Kasugamycin and Plant Resistance Elicitor in Onion (Var. Carta Blanca) for Controlling Burkholderia gladioli

Onion (var. carta blanca) were foliar sprayed with different formulations having Kasugamycin and plant resistance elicitor.

Formulation 1 of Kasugamycin and plant resistance elicitor was applied at a dosage of −0.9 g/kg of Kasugamycin (1.08 g/kg of Kasugamycin hydrochloride hydrate), 7.8 g/kg of Salicylic acid, 0.4 g/kg of inositol, 7.95 g/kg of fulvic acid, 0.225 g/kg of glucosamine, 1.35 g/kg of nitrogen, 0.075 g/kg of copper and 4.36 g/kg of K₂O.

Formulation 2 of Kasugamycin and plant resistance elicitor was applied at a dosage of −0.9 g/kg of Kasugamycin (1.08 g/kg of Kasugamycin hydrochloride hydrate), 9.08 g/kg of Salicylic acid, 0.63 g/kg of inositol, 9.27 g/kg of fulvic acid, 0.26 g/kg of glucosamine, 1.57 g/kg of nitrogen, 0.087 g/kg of copper and 5.09 g/kg of K₂O.

Formulation 3 of Kasugamycin and plant resistance elicitor was applied at a dosage of −0.9 g/kg of Kasugamycin (1.08 g/kg of Kasugamycin hydrochloride hydrate), 10.38 g/kg of Salicylic acid, 0.72 g/kg of inositol, 10.6 g/kg of fulvic acid, 0.3 g/kg of glucosamine, 1.8 g/kg of nitrogen, 0.1 g/kg of copper and 5.82 g/kg K₂O.

Two applications were made every 7 days from the stage of bulb maturation and % control of Burkholderia gladioli was determined. Control percentage of Burkholderia gladioli are illustrated in form of a graph in FIG. 3. Effect of the formulation is shown in FIG. 4, wherein “Control” indicates untreated, “K+OFE1:1.5” indicates Formulation 1, “K+OFE1:1.75” indicates Formulation 2 and “K+OFE1:2” indicates Formulation 3.

### Example 4: Foliar Application of Kasugamycin and Plant Resistance Elicitor in Banana (Var. Gran Enano) for Controlling Ralstonia solanacearum

Banana (var. Gran Enano) were foliar sprayed with different formulations having Kasugamycin and plant resistance elicitor.

Formulation 1 of Kasugamycin and plant resistance elicitor was applied at a dosage of −0.9 g/kg of Kasugamycin (1.08 g/kg of Kasugamycin hydrochloride hydrate), 7.8 g/kg of Salicylic acid, 0.4 g/kg of inositol, 7.95 g/kg of fulvic acid, 0.225 g/kg of glucosamine, 1.35 g/kg of nitrogen, 0.075 g/kg of copper, and 4.36 g/kg of K₂O.

Formulation 2 of Kasugamycin and plant resistance elicitor was applied at a dosage of −0.9 g/kg of Kasugamycin (1.08 g/kg of Kasugamycin hydrochloride hydrate), 10.38 g/kg of Salicylic acid, 0.72 g/kg of inositol, 10.6 g/kg of fulvic acid, 0.3 g/kg of glucosamine, 1.8 g/kg of nitrogen, 0.1 g/kg of copper, 5.82 g/kg of K₂O.

Formulation 3 of Kasugamycin and plant resistance elicitor was applied at a dosage of −0.9 g/kg of Kasugamycin (1.08 g/kg of Kasugamycin hydrochloride hydrate), 15.57 g/kg of Salicylic acid, 1.08 g/kg of inositol, 15.9 g/kg of fulvic acid, 0.45 g/kg of glucosamine, 2.7 g/kg of nitrogen, 0.15 g/kg of copper, 8.73 g/kg of K₂O.

Four applications were made every 7 days when the first symptoms of the disease appeared and % control of Ralstonia solanacearum was determined. Control percentage of Ralstonia solanacearum are illustrated in form of a graph in FIG. 5.

Based on the aforesaid studies, it could be concluded that the compositions including Kasugamycin or salt thereof and Kasugamycin and plant resistance elicitor exhibit wide spectrum of antibacterial and antifungal activities precluding development of resistance in phytopathogens. Further, it could be observed that the compositions aids in reducing phytotoxicity.

### ADVANTAGES

The present disclosure provides a new and improved agricultural composition that may overcome the limitations associated with the conventional agricultural compositions.

The present disclosure provides an agricultural composition that exhibits broad spectrum antifungal and antibacterial properties.

The present disclosure provides an agricultural composition that exhibits desired antifungal and antibacterial effect at lower dosage.

The present disclosure provides an agricultural composition that aid in precluding development of resistance of phytopathogens towards Kasugamycin or salt thereof.

The present disclosure provides an agricultural composition that is safe to use.

The present disclosure provides an agricultural composition that is cost-effective.

The present disclosure provides an agricultural composition that is easy to prepare.

1. An agricultural combination comprising kasugamycin or a salt thereof and a plant resistance elicitors in a weight ratio of 1:1 to 1:50.

2. The combination as claimed in claim 1, wherein the kasugamycin salt is kasugamycin hydrochloride hydrate and the plant resistance elicitor is selected from a metabolite, a nutrient sources, a seaweed extract, and combination thereof.

3. The combination as claimed in claim 2, wherein the nutrient source is selected from nitrogen, carbon, phosphorus, potassium, sulphur, copper, and combinations thereof.

4. An agricultural composition comprising kasugamycin or a salt thereof and a plant resistance elicitor in a weight ratio of 1:1 to 1:50, and an agriculturally acceptable excipient.

5. The composition as claimed in claim 4, wherein the kasugamycin salt is kasugamycin hydrochloride hydrate.

6. The composition as claimed in claim 4, wherein the plant resistance elicitor is selected from a metabolite, a nutrient source, a seaweed extract, and combinations thereof.

7. The composition as claimed in claim 6, wherein the metabolite is selected from the group consisting of fulvic acid, salicylic acid, steroids, saponins flavonoids, phenylpropanoids, lignins, coumarins, lignins, polyacetylenes, terpenes, fatty acids, lectins, polypeptides, waxes, and companions thereof; wherein the nutrient is selected from the group consisting of carbon, hydrogen, nitrogen, oxygen, phosphorus, potassium, calcium, magnesium, sulfur, boron, chlorine, copper, iron, manganese, molybdenum, zinc, cobalt, and combinations thereof, and/or the seaweed extract is Ascophyllum nodosum.

8. The composition as claimed in claim 4, wherein kasugamycin or a salt thereof is in an amount ranging from 0.1% to 40% (w/v) by weight of the composition, and the plant elicitor is in an amount ranging from 5% to 70% (w/v) by weight of the composition.

9. The composition as claimed in claim 6, wherein the composition comprises kasugamycin or a salt thereof in an amount ranging from 0.1% to 40% (w/v), a metabolite in an amount ranging from 0.5%-35% (w/v), a seaweed extract in an amount ranging from 0.01%-10% (w/v), a nutrient source in an amount ranging from 0.05%-15% (w/v), and the agriculturally acceptable excipient in an amount ranging from 5% to 95% (w/v) by weight of the composition.

10. (canceled)

11. The composition as claimed in claim 4, wherein the composition is liquid.

12. The composition as claimed in claim 4, wherein the composition further comprises an herbicide, a fungicide, an insecticide or an acaricide.

13. A liquid agricultural composition comprising kasugamycin or a salt thereof in an amount ranging from 0.1% to 40% (w/v), a metabolites, in an amount ranging from 0.5%-35% (w/v), a seaweed extract in an amount ranging from 0.01%-10% (w/v), a nutrient source in an amount ranging from 0.05%-15% (w/v), and an excipient in an amount ranging from 5% to 95% (w/v).

14. The composition as claimed in claim 13, wherein the weight ratio of kasugamycin or a salt thereof and the plant resistance elicitor compound is from 1:1 to 1:50.

15. (canceled)

16. A method of controlling phytopathogens comprising applying at the locus of infection by the phytopathogen, to a plant, to a plant part, or to a plant propagation material the combination of claim 1.

17. The method as claimed in claim 16, wherein the weight ratio of kasugamycin or the salt thereof and a plant resistance elicitor is from 1:1 to 1:40.
